(19) United States
(12) Patent Application Publication
(10) Pub. No.: US 2002/0172779 A1
(43) Pub. Date: Nov. 21, 2002

(54) Treating cavitated polymeric films with plasma at atmospheric pressure

(76) Inventor: Jeffrey J. O'Brien, Walworth, NY (US)

Correspondence Address: ExxonMobil Chemical Company, P.O. Box 2149, Baytown, TX, 77522, US

(21) Appl. No.: 09/829,758

(22) Filed: Apr. 10, 2001

(51) Int. Cl. H05H 1/24

(52) U.S. Cl. 427/569

(57) ABSTRACT

A method is provided for surface treating a polymeric film. The film may be biaxially oriented and includes void spaces or cavities in a thermoplastic polymer matrix. The surface treatment involves contacting at least one surface of the film with plasma at atmospheric pressure and at a temperature below the melting point of the thermoplastic polymer of the matrix material. This method makes the treated surfaces more hydrophilic.

### BACKGROUND

A method is provided for surface treating a polymeric film. The film includes void spaces or cavities in a thermoplastic polymer matrix. The surface treatment involves contacting at least one surface of the film with plasma at atmospheric pressure and at a temperature below the melting point of the thermoplastic polymer of the matrix material. This method makes the treated surfaces more hydrophilic.

Flame, plasma or corona discharge treatments have been used to improve the printability or metal adhesion properties of film surfaces of polymers, such as polypropylene. These treatments are believed to generate oxygen containing functional groups, such as —OH or —COOH, on exposed surfaces of the film. Plasma treatment in the presence of a hydroxyl-donating material, such as methanol, is described in U.S. Pat. No. 5,981,079.

Flame, corona discharge and some plasma treatments tend to involve subjecting the treated film surfaces to high temperatures. These high temperatures may tend to melt or distort the polymer.

Monolayer and multilayer films may include void spaces or cavities in one or more layers. For example, U.S. Pat. No. 4,632,869 describes the generation of a cavitated (i.e. void containing) film by biaxially orienting a film including a blend of a polybutylene terephthalate cavitating agent in a thermoplastic polymer matrix. The voids generated in this process impart opacity to the film.

Exposing a cavitated (i.e. void containing) film to high temperatures can be particularly problematic. For example, U.S. Pat. No. 5,650,451 states that treatment of a porous biaxially oriented high molecular weight film at a temperature of 132 to 145° C. for one second to ten minutes can result in a loss of specific surface area of 20 m²/g or more.

Cavitated films may have an open cell or closed cell structure. The films prepared by the method of the above-mentioned U.S. Pat. No. 4,632,869 tend to have a closed cell structure, whereas the films prepared by the method of the above-mentioned U.S. Pat. No. 5,650,451 tend to have an open cell structure. In the open cell structure, void spaces are continuous or interconnected so as to form pores which have an opening on at least one surface of the film layer. In a closed cell structure, the void spaces are disconnected, for example, in the form of bubbles, which are isolated from the surfaces of the film layer by a continuous polymeric matrix.

Plasma treatment by be conducted under vacuum conditions, such as a pressure of 0.01 mbar. However, when a cavitated film, particularly one having void spaces encapsulated or surrounded by a continuous polymeric matrix, is subjected to such vacuum conditions, the void spaces (e.g., bubbles) can rupture, thereby damaging the film.

### SUMMARY

There is provided a method for surface treating a polymeric film structure comprising a thermoplastic polymer matrix material having void spaces therein, said method comprising contacting at least one surface of said film with plasma at atmospheric pressure at a temperature below the melting point of said thermoplastic polymer matrix material. The film structure may be biaxially oriented.

### DETAILED DESCRIPTION

Examples of thermoplastic polymer matrix materials include the polyolefins, such as polyethylene, polypropylene, polybutylene, etc. Included also are distinct species of these materials such as ultra low density polyethylene (ULDPE), low density polyethylene (LDPE), high density polyethylene (HDPE), linear low density ethylene copolymerized with less than 10% by weight of another alpha olefin e.g. propylene, butylene, etc., random copolymers of propylene with another olefin, e.g. ethylene, butylene, hexene, etc. and any blend or mixtures of the same. Other thermoplastic polymer matrix materials include polystyrene and blends thereof with polyolefins.

An incompatible material, also referred to herein as a cavitating agent, may be blended with the thermoplastic polymer matrix material to provide a voided layer. Such agents may be added to the matrix material prior to extrusion and are capable of generating voids (cavities) in the structure of the film during the film-making process. It is believed that small inhomogeneities introduced into the matrix layer by the cavitating agent result in points of weakness in the polymer sheet. The biaxially orienting step then induces separations in the matrix layer, causing cavitation in the processed film. The separations in the cavitated layer vary in size and may be formed not only horizontally, i.e., within or parallel to the plane of the film, but also in the vertical dimension or perpendicular to the plane of the film.

Inorganic cavitating agents may be used. A particular cavitating agent is calcium carbonate (CaCO₃).

Organic cavitating agents, such as polystyrene and polybutylene terephthalate (PBT), may be used. When used, the organic cavitating agents may be extremely finely divided and resistant to melting at operating temperatures in order to produce the desired degree of inhomogeneity in the polymer sheet. Crosslinked polymeric cavitating agents tend to be particularly melt resistant. Cavitating agents can be included using methods known in the art, such as that described in U.S. Pat. Nos. 4,377,616 and 4,632,869, incorporated herein by reference.

The percentage of cavitating agent included in the matrix layer may be from 2 wt % to 40 wt %, for example, from 4 wt % to 24 wt %, e.g., from 7 wt % to 18 wt %.

The blend of matrix polymer and cavitating agent may be passed through a flat sheet extruder die at a temperature ranging from about 230° C. to about 280° C. This layer may be coextruded with one or more skin layers to form a multi-layer film. The extruded layers may be cast onto a cooling drum, quenched and stretched to achieve biaxial orientation.

Conventional casting apparatus may be used to prepare the present film. For example, cast extrusion may use a standard multi-roll stack system or a cast roll with an air cap (high velocity air applied to the outside of the sheet). A cast roll and water bath system may be used, although this type of system can affect film clarity, generally yielding a rougher and more opaque film.

Biaxial orientation of the present film tends to evenly distribute strength qualities of a film in the longitudinal or “machine direction” (MD) of the film and in the lateral or “transverse direction” (TD) of the film. Biaxial oriented films tend to be stiffer and stronger, and also exhibit much better resistance to flexing and folding forces.

Biaxial orientation can be conducted simultaneously in both directions, however, it is expensive to employ apparatus having the ability to do this. Therefore, most biaxial orientation processes use apparatus which stretches the films sequentially, first in one direction and then in the other, preferably in the MD first and then in the TD. A discussion of high biaxial orientation of polyethylene films is provided in U.S. Pat. No. 5,885,721. The present films may, for example, be stretched in the MD from about 5:1 to about 8:1 and in the TD from about 6:1 to about 15:1.

The present films may be in the form of monolayer cavitated films or multilayer films including at least one cavitated layer. The present film may have more than one cavitated layer. For example, such a three layer film may have a cavitated surface layer, a cavitated core layer and a noncavitated (i.e. void free) thermoplastic skin layer. Other examples of multilayer films include those with both skin layers being cavitated, optionally including one or more core layers, which may or may not be cavitated. One or more cavitated layers may also be included within skin layers which are both not cavitated.

Any of the layers of the present film, whether cavitated or not cavitated, may optionally include various additives. Such additives include, but are not limited to, anti-blocks, anti-static agents, coefficient of friction (COF) modifiers, processing aids, colorants, clarifiers, and other additives known to those skilled in the art.

The skin layers may be rather thin, for example, having a combined thickness of less than 25% of the total film thickness. These skin layers may each have a thickness of, for example, 0.05 mil or less.

The present films are plasma treated on one or both surfaces under atmospheric conditions, i.e. conditions where a vacuum is not applied during treatment. Such atmospheric plasma treatments are described in U.S. Pat. No. 6,118,218 and in an article by S. A. Pirzada, A. Yializis, W. Decker and R. E. Ellwanger, entitled “Plasma Treatment of Polymer Films”, Society of Vacuum Coaters 42^{nd} Annual Technical Conference Proceedings, Chicago, 1999, pp. 301-306. By means of this atmospheric plasma treatment, it is possible to apply plasma to the cavitated polyolefin surface at a temperature less than the melting point of the polyolefin, e.g., less than 130° C. or even less than 100° C. Equipment for making such plasma treatments at or near atmospheric pressures is available from Sigma Technologies International, Inc., 10960 N. Stallard Place, Tucson, Ariz. An operating frequency of 40 kHz is recommended for plasma treatment of polymer surfaces.

An advantage of the atmospheric plasma treatment is that it can take place under conditions insufficient to generate enough heat to melt polymers or otherwise distort the structure of the film, especially the cavitated portions thereof. By way of contrast, U.S. Pat. No. 5,650,451 states that treatment of a biaxially oriented high molecular weight film at a temperature of 132 to 145° C. for one second to ten minutes can result in a loss of specific surface area of 20 m²/g or more.

When penetration of plasma into the open pores of the of an open celled film is desired, the operating frequency may be rather high. In particular, the frequency of the plasma generating electrode for pore penetration may be greater than 1 MHz, such as at least 5 MHz, for example, from 5 MHz to 20 MHz.

The plasma treating gas may include one or more of a variety of gases including oxygen, nitrogen, air, carbon dioxide, methane and other inert or reactive gases. For example, an oxygen containing gas, such as O₂, CO₂ or air, may be used alone or, optionally, in admixture with an inert gas, such as argon or helium.

The present atmospheric plasma treatment may optionally take place in the presence of a hydroxyl-donating material, such as methanol, in accordance with techniques described in U.S. Pat. No. 5,981,079.

### EXAMPLE 1

This Example describes the preparation of a cavitated HDPE film having an open celled pore structure.

A three layer porous HDPE film was prepared. The film structure included a top porous skin layer A, and porous core layer B, and a bottom skin layer C.

The top porous skin layer A included 90 wt % HDPE (Exxon 7845.30) as the polymer matrix material, 9 wt % CaCO₃ and 1 wt % fluoropolymer as an internal lubricant. The CaCO₃ and fluoropolymer were both added in the form of a masterbatch with the polymer matrix material. More particularly, the top porous skin layer A included 79 wt % HDPE (Exxon 7845.30) as the polymer matrix material, 18 wt % CaCO₃ masterbatch containing 50 wt % CaCO₃, and 1 wt % fluoropolymer as an internal lubricant.

The porous core layer B included 94 wt % HDPE (Exxon 7845.30) as the polymer matrix material, and 6 wt % CaCO₃. The CaCO₃ was both added in the form of a masterbatch with the polymer matrix material. More particularly, the porous core layer B included 88 wt % HDPE (Exxon 7845.30) as the polymer matrix material, and 12 wt % CaCO₃ masterbatch containing 50 wt % CaCO₃.

The bottom skin layer was a medium density polyethylene (MDPE) (Dowlex 2027A) with a minor amount of antiblock additives.

The total polymer gauge (without cavitation) is 1.4 mil. The cavitated film gauge after biaxial orientation was 4.5 mil. The total polymer gauge can be calculated from the polymer weight and density.

The polymer mixtures of the layers were extruded at around 250° C. into a base sheet, which is then stretched 5 times in the machine direction (MD) and 8 times in the transitional direction (TD).

### EXAMPLE 2

The porous surfaces of two film samples (i.e. Sample 1 and Sample 2), prepared according to the procedure of Example 1, were treated with plasma at atmospheric conditions. The plasma gas was 100% oxygen.

Each film sample was treated with plasma generated at two different frequencies, i.e. 40 kHz and 13.5 MHz. Electron Spectroscopy for Chemical Analysis (ESCA) was used to measure the elements present after treatment, in terms of atomic equivalents of total oxygen (O); total carbon (C); carbon singly bound to carbon or hydrogen [C—(C,H)]; hydroxyl and ether groups [C—(O,N)]; carbonyl groups (C═O); and ester and carboxylic acid groups (O—C═O).

Results are summarized in Table 1. In Table 1 all percentages are atom percents.

TABLE 1

| Sam- | | | | | | | |
|---|---|---|---|---|---|---|---|
| ple | Fre- | | | C—(C,H) | C—(O,N) | C═O | O—C═O |
| No. | quency | O % | C % | % | % | % | % |
| 1 | 13.5 | 11.4 | 87.3 | 78 | 5 | 2 | 2 |
| | MHz | | | | | | |
| 1 | 40 kHz | 18.2 | 79.4 | 64 | 9 | 4 | 2 |
| 2 | 13.5 | 11.2 | 87.9 | 79 | 4 | 2 | 2 |
| | MHz | | | | | | |
| 2 | 40 kHz | 17.3 | 81.6 | 65 | 9 | 4 | 4 |

Table 1 illustrates that in all cases the 40 kHz treatment had a higher level of oxygen and a higher level of oxygen-bonding atoms vs. the 13.5 frequency plasma treatment. Similar results were obtained when a non-porous polypropylene film was treated with 40 kHz and 13.5 MHz plasma.

### EXAMPLE 3

Film samples, prepared according to the procedure of Example 1, were treated with plasma according to the treatment procedures described in Example 2.

These treated samples were tested for water wicking according to the Cahn Wicking test. Total water wicking was greater for the samples treated at 40 kHz, as compared with the samples prepared at 13.5 MHz. For example, as explained in Example 7, hereinafter, when a film sample treated at 40 kHz was tested for water wicking, its weight increased by 253.00 mg. However, when an equivalent sample treated at 13.5 MHz was tested, the weight increased by only 153.09 mg.

As expected, for a given frequency, increased power and increased treatment time resulted in increased water wicking.

### EXAMPLE 4

The wicking tests of Example 3 were repeated, except that dye and pigment based inks were wicked into the samples instead of water. For the most part, the 40 kHz treated film absorbed the most weight of ink. However, the difference in weights was not as great as with water.

### EXAMPLE 5

Film samples, prepared according to the procedure of Example 1, were treated with plasma according to the treatment procedures described in Example 2.

These treated samples were tested for ink drying time with various inks, including a hard to dry low humectant, ink applied by ink jet printing. Ink drying time was less for the samples treated with the 13.5 MHz frequency plasma.

### EXAMPLE 6

Film samples (i.e. Samples 3-6), prepared according to the procedure of Example 1, were treated with plasma according to the treatment procedures described in Example 2.

These treated samples were tested for ink infiltration. In particular, a cut cross section of inkjet printed film was viewed on an optical microscope to compare how far the ink soaked into the film. Infiltration percent was measured by multiplying the depth of ink penetration by 100 and dividing by the total film thickness.

Results are summarized in Table 2. This Table also reports the maximum amount of ink wicking for both dye ink and pigment ink.

TABLE 2

| Sam- | | | | | |
|---|---|---|---|---|---|
| ple | Plasma | Max Dye | Dye Ink | Max Pigment | Pigment Ink |
| No. | Frequency | Wicking | Infiltration | Wicking | Infiltration |
| 3 | 40 kHz | 181.92 | 13.27% | 156.06 | 39.47% |
| 3 | 13.5 MHz | 170.10 | 40.00% | 160.05 | 58.08% |
| 4 | 40 kHz | 173.10 | 13.19% | 156.58 | 26.66% |
| 4 | 13.5 MHz | 164.27 | 22.64% | 150.23 | 25.48% |
| 5 | 40 kHz | 199.87 | 11.92% | 175.44 | 36.49% |
| 5 | 13.5 MHz | 181.67 | 30.77% | 160.39 | 34.61% |
| 6 | 13.5 MHz | 190.04 | 30.28% | 165.12 | 46.51% |

The test results summarized in Table 2 demonstrate that the 13.5 MHz frequency treatment allows ink to penetrate deeper into the film, especially when dye inks are used.

### EXAMPLE 7

Samples of the film of Example 1, corona treated or treated with plasma at a frequency of 40 kHz, were tested to measure water absorption into the film by the Cahn Wicking test. This test dips a one inch sample of film into a beaker of water and continuously measures the weight of the sample. The initial weight is set to zero and the weight gain or loss is the amount of water absorbed by the sample. If the sample is hydrophobic and has a density less than water, the sample measurement will be negative because of buoyancy. If the sample hydrophilic and has a density less than water, the sample measurement will start out negative and after some time, as water is absorbed into the sample, end up positive. If the sample is hydrophilic and has a density less than water, the sample measurement could always be positive, if the absorption rate is fast.

In the wicking test, the corona treated sample gave an initial water absorption value of −27.5 mg and a maximum water absorption value of 9.82 mg. These values indicate that the corona treatment failed to make the sample hydrophilic.

In the same wicking test, the plasma treated sample gave an initial water absorption value of 231.72 mg and a maximum water absorption value of 253.00 mg. These values indicate that the plasma treatment made the sample hydrophilic.

### EXAMPLE 8

A sample of the Teslin™ film, available from PPG Industries, Inc., was treated with plasma at a frequency of 40 kHz, and tested to measure water absorption into the film by the Cahn Wicking test. An untreated sample was also tested by this test.

In the wicking test, the untreated Teslin™ sample gave an initial water absorption value of −399.27 mg and a maximum water absorption value of −372.63 mg. These values indicate that the untreated sample was very hydrophobic.

In the same wicking test, the plasma treated Teslin™ sample gave an initial water absorption value of 150.72 mg and a maximum water absorption value of 181.27 mg. These values indicate that the plasma treatment made the sample hydrophilic.

What is claimed is:

1. A method for surface treating a polymeric film structure comprising a thermoplastic polymer matrix material having void spaces therein, said method comprising contacting at least one surface of said film with plasma at atmospheric pressure and at a temperature below the melting point of said thermoplastic polymer matrix material.

2. A method according to claim 1, wherein said polymeric matrix material is polypropylene.

3. A method according to claim 1, wherein said polymeric matrix material is polyethylene.

4. A method according to claim 1, wherein said film is a monolayer cavitated film.

5. A method according to claim 1, wherein said film is a multilayer film with at least one cavitated skin layer.

6. A method according to claim 1, wherein said film is a multilayer film with at least one noncavitated skin layer.

7. A method according to claim 6, wherein said multilayer film has a cavitated core layer, and wherein both skin layers are not cavitated.

8. A method according to claim 1, wherein said film is biaxially oriented and at least one layer of said film comprises a cavitating agent.

9. A method according to claim 1, wherein said film has at least one cavitated layer with an open cell structure.

10. A method according to claim 1, wherein said film has at least one cavitated layer with a closed cell structure.
